(19) United States
(12) Patent Application Publication
(10) Pub. No.: US 2006/0064531 A1
(43) Pub. Date: Mar. 23, 2006

(54) Method and system for optimizing data transfer in networks

(76) Inventors: Jerald K. Alston, Coto de Caza, CA (US); Oscar J. Grijalva, Cypress, CA (US)

Correspondence Address: KLEIN, O'NEILL & SINGH, 2 PARK PLAZA, SUITE 510, IRVINE, CA, 92614, US

(21) Appl. No.: 10/948,404

(22) Filed: Sep. 23, 2004

(51) Int. Cl. G06F 13/36

(52) U.S. Cl. 710/308

(57) ABSTRACT

A method and system for transferring data from a host system to plural devices is provided. Each device may be coupled to a link having a different serial rate for accepting data from the host system. The system includes plural programmable DMA channels, which are programmed to concurrently transmit data at a rate at which the receiving devices will accept data. The method includes programming a DMA channel that can transmit data at a rate similar to the rate at which the receiving device will accept data.

### BACKGROUND

1. Field of the Invention

The present invention relates to networking systems, and more particularly to programming direct memory access (“DMA”) channels to transmit data at a rate(s) similar to a rate at which a receiving device can accept data.

2. Background of the Invention

Storage area networks (“SANs”) are commonly used where plural memory storage devices are made available to various host computing systems. Data in a SAN is typically moved from plural host systems (that include computer systems) to the storage system through various controllers/adapters.

Host systems often communicate with storage systems via a host bus adapter (“HBA”, may also be referred to as a “controller” and/or “adapter”) using the “PCI” bus interface. PCI stands for Peripheral Component Interconnect, a local bus standard that was developed by Intel Corporation®. The PCI standard is incorporated herein by reference in its entirety. Most modern computing systems include a PCI bus in addition to a more general expansion bus. PCI is a 64-bit bus and can run at clock speeds of 33,66 or 133 MHz.

PCI-X is another standard bus that is compatible with existing PCI cards using the PCI bus. PCI-X improves the data transfer rate of PCI from 132 MBps to as much as 1 gigabits per second. The PCI-X standard (incorporated herein by reference in its entirety) was developed by IBM®, Hewlett Packard Corporation® and Compaq Corporation® to increase performance of high bandwidth devices, such as Gigabit Ethernet standard and Fibre Channel Standard, and processors that are part of a cluster.

Various other standard interfaces are also used to move data from host systems to storage devices. Fibre channel is one such standard. Fibre channel (incorporated herein by reference in its entirety) is an American National Standard Institute (ANSI) set of standards, which provides a serial transmission protocol for storage and network protocols such as HIPPI, SCSI, IP, ATM and others. Fibre channel provides an input/output interface to meet the requirements of both channel and network users.

Fiber channel supports three different topologies: point-to-point, arbitrated loop and fiber channel fabric. The point-to-point topology attaches two devices directly. The arbitrated loop topology attaches devices in a loop. The fiber channel fabric topology attaches host systems directly to a fabric, which are then connected to multiple devices. The fiber channel fabric topology allows several media types to be interconnected.

iSCSI is another standard (incorporated herein by reference in its entirety) that is based on Small Computer Systems Interface (“SCSI”), which enables host computer systems to perform block data input/output (“I/O”) operations with a variety of peripheral devices including disk and tape devices, optical storage devices, as well as printers and scanners.

A traditional SCSI connection between a host system and peripheral device is through parallel cabling and is limited by distance and device support constraints. For storage applications, iSCSI was developed to take advantage of network architectures based on Fibre Channel and Gigabit Ethernet standards. iSCSI leverages the SCSI protocol over established networked infrastructures and defines the means for enabling block storage applications over TCP/IP networks. iSCSI defines mapping of the SCSI protocol with TCP/IP.

SANS today are complex and move data from storage sub-systems to host systems at various rates, for example, at 1 gigabits per second (may be referred to as “Gb” or “Gbps”), 2 Gb, 4 Gb, 8 Gb and 10 Gb. The difference in transfer rates can result is bottlenecks as described below with respect to FIG. 1C. It is noteworthy that although the example below is with respect to a SAN using the Fibre Channel standard, the problem can arise in any networking environment using any other standard or protocol.

FIG. 1C shows an example of a host system 200 connected to fabric 140 and devices 141, 142 and 143. Host system (includes computers, file server systems or similar devices) 200 with controller 106 and ports 138 and 139 is coupled to fabric 140. In turn, switch fabric 140 is coupled to devices 141, 142 and 143. Devices 141, 142 and 143 may be stand-alone disk storage systems or multiple disk storage systems (e.g. a RAID system, as described below). Devices 141, 142 and 143 are coupled to fabric 140 at different link data transfer rates. For example, device 141 has a link that operates at 1 Gb, device 142 has a link that operates at 2 Gb, and device 143 has a link that operates at 4 Gb.

Host system 200 may use a high-speed link for transferring data; for example, a 10 Gb link to send data to devices 141, 142 and 143 respectively. Switch fabric 140 typically uses a data buffer 144 to store data that is sent by host system 200, before the data is transferred to any of the connected devices. Fabric 140 attempts to absorb the difference in the transfer rates by using standard buffering and flow control techniques.

A problem arises when a device (e.g. host system 200) using a high-speed link (for example, 10 Gb) sends data to a device coupled to a link that operates at a lower rate (for example, 1 Gb). When host system 200 transfers' data to switch fabric 140 intended for devices 141, 142 and/or 143, data buffer 144 becomes full. Once buffer 145 is full, standard fibre channel flow control process is triggered. This applies backpressure to the sending device (in this example, host system 200). Thereafter, host system 200 has to reduce its data transmission rate to the receiving device's link rate. This results in high-speed bandwidth degradation.

One reason for this problem is that typically a DMA channel in the sending device (for example, host system 200) is set up for the entire data block that is to be sent. Once the frame transfer rate drops due to backpressure, the DMA channel set-up is stuck until the transfer is complete.

Therefore, what is required is a system and method that allows a host system to use a data transfer rate that is based upon a receiving device's capability to receive data.

### SUMMARY OF THE INVENTION

In one aspect of the present invention, a system for transferring data from a host system to plural devices is provided. Each device may be coupled to a link having a different serial rate for accepting data from the host system. The system includes plural DMA channels operating concurrently and programmed to transmit data at rates similar to the rates at which the receiving devices will accept data.

In another aspect of the present invention, a circuit is provided, for transferring data from a host system to plural devices. The circuit includes plural DMA channels operating concurrently and programmed to transmit data at rates similar to the rates at which the receiving devices will accept data.

In yet another aspect of the present invention, a method is provided for transferring data from a host system coupled to plural devices wherein the plural devices may accept data at different serial rates. The method includes programming plural DMA channels that can concurrently transmit data at rates similar to the rate(s) at which the receiving devices will accept data.

In yet another aspect of the present invention, a high-speed data transfer link is used efficiently to transfer data based upon the acceptance rate of a receiving device.

This brief summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A is a block diagram showing various components of a SAN;

FIG. 1B is a block diagram of a host bus adapter that uses plural programmable DMA channels to transmit data at different rates for different I/Os' (input/output); according to one aspect of the present invention;

FIG. 1C shows a block diagram of a fiber channel system using plural transfer rates resulting in high-speed bandwidth degradation,

FIG. 1D shows a block diagram of a transmit side DMA module, according to one aspect of the present invention;

FIG. 2 is a block diagram of a host system used according to one aspect of the present invention; and

FIG. 3 is a process flow diagram of executable steps for programming plural DMA channels to transmit data at different rates for different I/Os', according to one aspect of the present invention; and

FIG. 4 shows a RAID topology that can use the adaptive aspects of the present invention.

The use of similar reference numerals in different figures indicates similar or identical items.

### DETAILED DESCRIPTION OF THE PREFERRED EMBODIMENTS

### DEFINITIONS

The following definitions are provided as they are typically (but not exclusively) used in the fiber channel environment, implementing the various adaptive aspects of the present invention.

“Fiber channel ANSI Standard”: The standard, incorporated herein by reference in its entirety, describes the physical interface, transmission and signaling protocol of a high performance serial link for support of other high level protocols associated with IPI, SCSI, IP, ATM and others.

“Fabric”: A system which interconnects various ports attached to it and is capable of routing fiber channel frames by using destination identifiers provided in FC-2 frame headers.

“RAID”: Redundant Array of Inexpensive Disks, includes storage devices connected using interleaved storage techniques providing access to plural disks.

“Port”: A general reference to N. Sub.—Port or F. Sub.—Port.

To facilitate an understanding of the preferred embodiment, the general architecture and operation of a SAN, a host system and a HBA will be described. The specific architecture and operation of the preferred embodiment will then be described with reference to the general architecture of the host system and HBA.

SAN Overview:

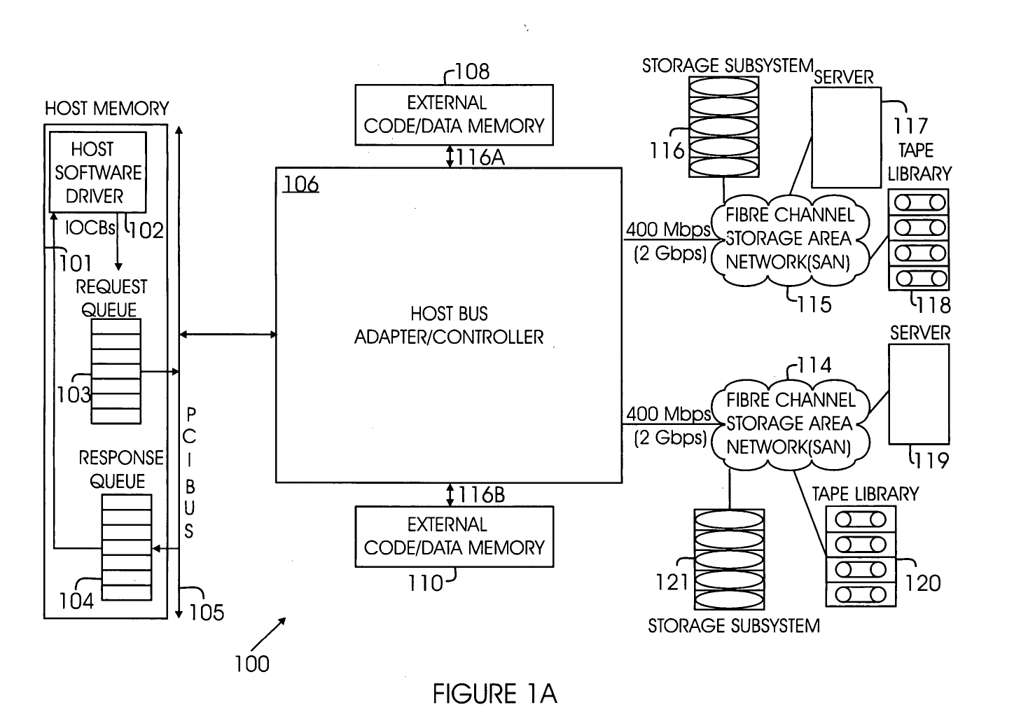

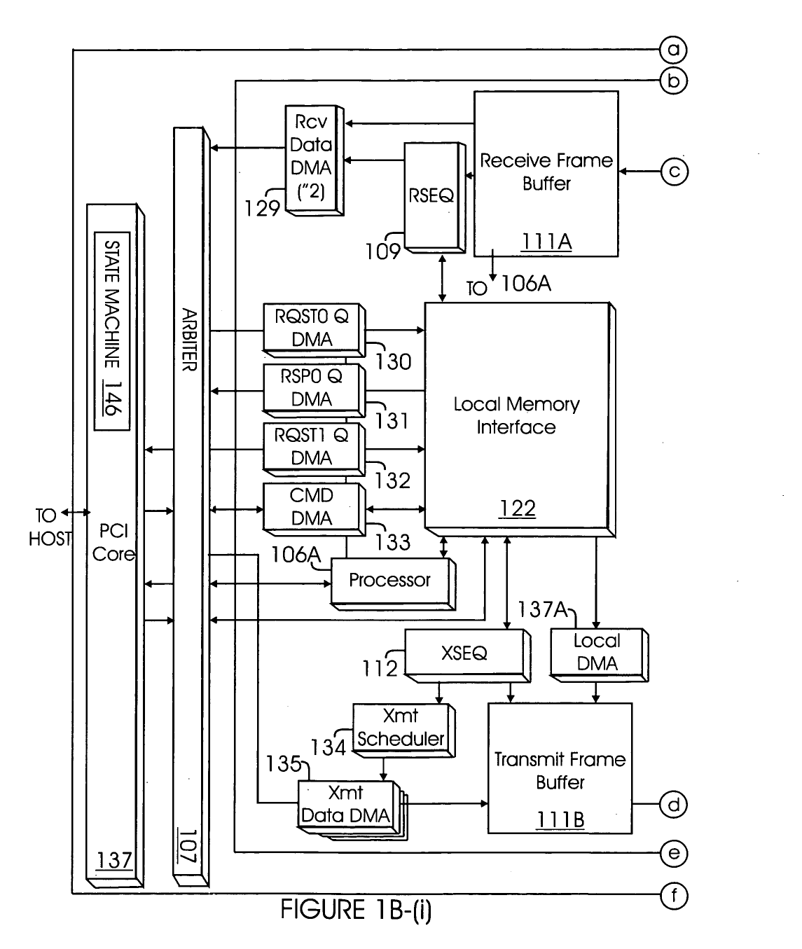

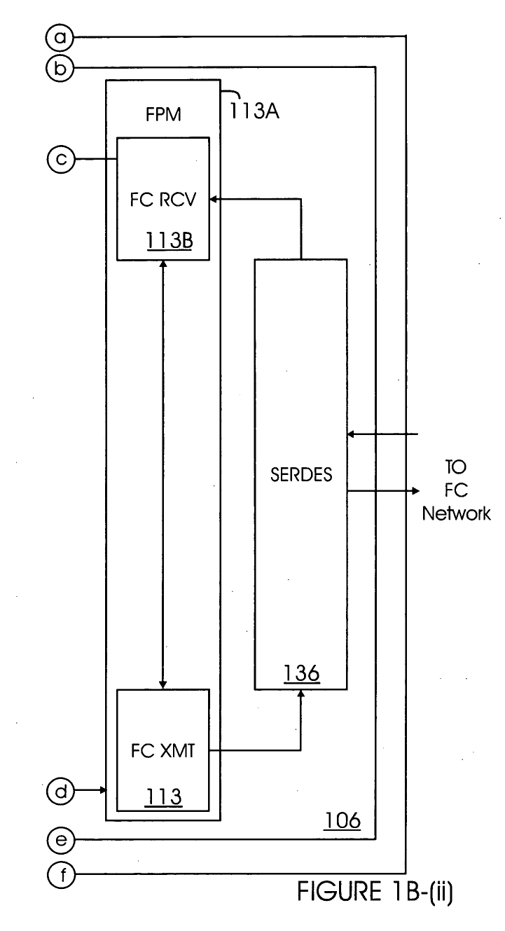

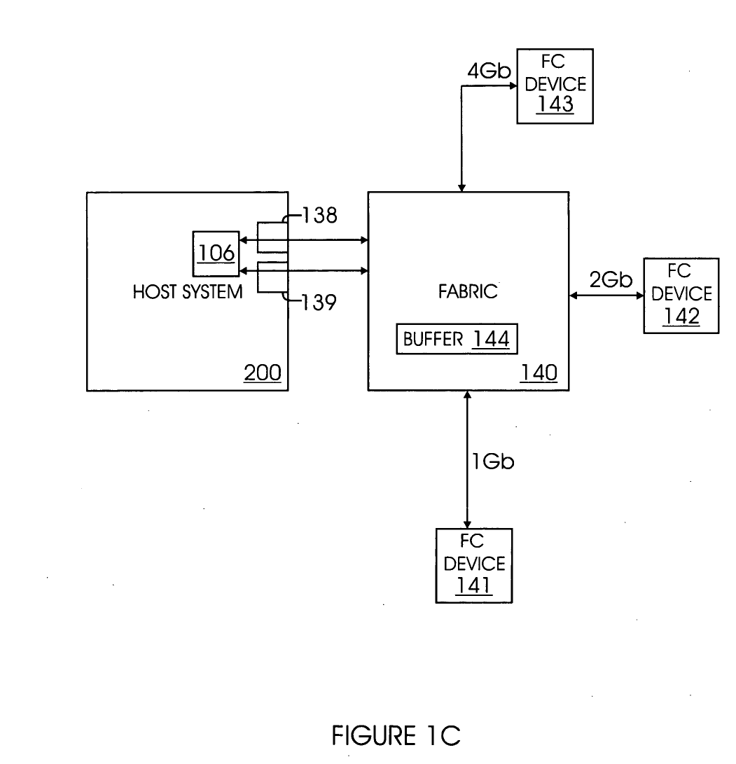

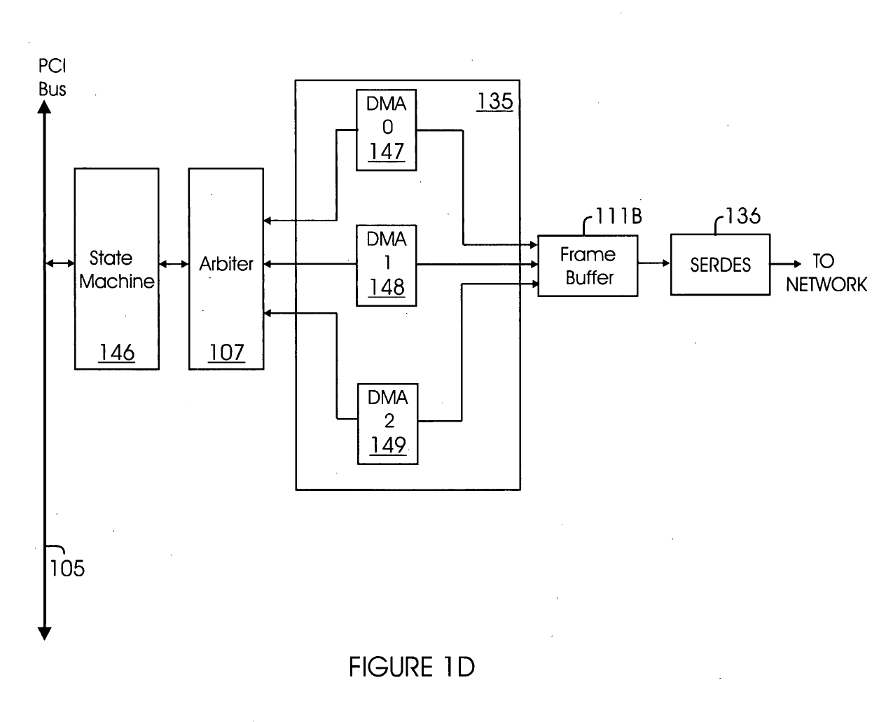

FIG. 1A shows a SAN system 100 that uses a HBA 106 (referred to as “adapter 106”) for communication between a host system ((for example, 200, FIG. 1C) with host memory 101) with various systems (for example, storage subsystem 116 and 121, tape library 118 and 120, and server 117) using fibre channel storage area networks 114 and 115. Host system 200 uses a driver 102 that co-ordinates data transfers via adapter 106 using input/output control blocks (“IOCBs”)

A request queue 103 and response queue 104 is maintained in host memory 101 for transferring information using adapter 106. Host system 200 communicates with adapter 106 via a PCI bus 105 through a PCI core module (interface) 137, as shown in FIG. 1B.

Host System 200:

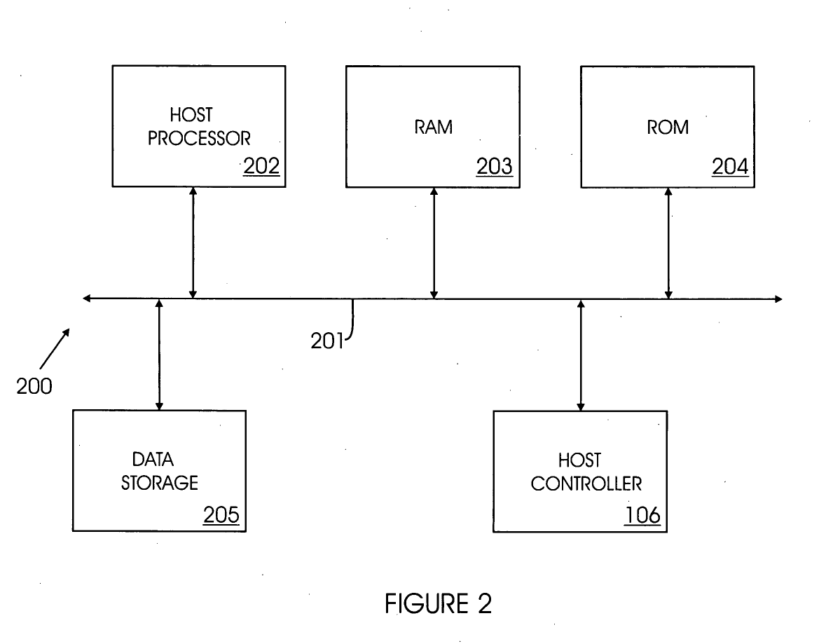

FIG. 2 shows a block diagram of host system 200 representing a computer, server or other similar devices, which may be coupled to a fiber channel fabric to facilitate communication. In general, host system 200 typically includes a host processor 202 that is coupled to computer bus 201 for processing data and instructions. In one aspect of the present invention, host processor 202 may be a Pentium Class microprocessor manufactured by Intel Corp™.

A computer readable volatile memory unit 203 (for example, a random access memory unit also shown as system memory 101 (FIG. 1A) and used interchangeably in this specification) may be coupled with bus 201 for temporarily storing data and instructions for host processor 202 and/or other such systems of host system 200.

A computer readable non-volatile memory unit 204 (for example, read-only memory unit) may also be coupled with bus 201 for storing non-volatile data and instructions for host processor 202. Data Storage device 205 is provided to store data and may be a magnetic or optical disk.

HBA 106:

FIG. 1B shows a block diagram of adapter 106. Adapter 106 includes processors (may also be referred to as “sequencers”) 112 and 109 for transmit and receive side, respectively for processing data received from storage sub-systems and transmitting data to storage sub-systems. Transmit path in this context means data path from host memory 101 to the storage systems via adapter 106. Receive path means data path from storage subsystem via adapter 106. It is noteworthy, that only one processor is used for receive and transmit paths, and the present invention is not limited to any particular number/type of processors. Buffers 111A and 111B are used to store information in receive and transmit paths, respectively.

Beside dedicated processors on the receive and transmit path, adapter 106 also includes processor 106A, which may be a reduced instruction set computer (“RISC”) for performing various functions in adapter 106.

Adapter 106 also includes fibre channel interface (also referred to as fibre channel protocol manager “FPM”) 113A that includes an FPM 113B and 113 in receive and transmit paths, respectively. FPM 113B and FPM 113 allow data to move to/from devices 141, 142 and 143 (as shown in FIG. 1C).

Adapter 106 is also coupled to external memory 108 and 110 (referred interchangeably hereinafter) through local memory interface 122 (via connection 116A and 116B, respectively, (FIG. 1A)). Local memory interface 122 is provided for managing local memory 108 and 110. Local DMA module 137A is used for gaining access to move data from local memory (108/110).

Adapter 106 also includes a serial/de-serializer (“SERDES”) 136 for converting data from 10-bit to 8-bit format and vice-versa.

Adapter 106 further includes request queue DMA channel (0) 130, response queue DMA channel 131, request queue (1) DMA channel 132 that interface with request queue 103 and response queue 104; and a command DMA channel 133 for managing command information.

Both receive and transmit paths have DMA modules 129 and 135, respectively. Transmit path also has a scheduler 134 that is coupled to processor 112 and schedules transmit operations. Plural DMA channels run simultaneously on the transmit path and are designed to send frame packets at a rate similar to the rate at which a device can receive data. Arbiter 107 arbitrates between plural DMA channel requests.

DMA modules in general (for example, 135 that is described below with respect to FIG. 1D, and 129) are used to perform transfers between memory locations, or between memory locations and an input/output port. A DMA module functions without involving a microprocessor by initializing control registers in the DMA unit with transfer control information. The transfer control information generally includes source address (the address of the beginning of a block of data to be transferred), the destination address, and the size of the data block.

For a write command, processor 202 sets up shared data structures in system memory 101. Thereafter, information (data/commands) is moved from host memory 101 to buffer memory 108 in response to the write command.

Processor 112 (OR 106A) ascertains the data rate at which a receiving end (device/link) can accept data. Based on the receiving ends acceptance rate, a DMA channel is programmed to transfer data at that rate. The knowledge of a receiving devices' link speed can be obtained using Fibre Channel Extended Link Services (ELS's) or by other means such as communication between the sending host system (or sending device) and the receiving device. Plural DMA channels may be programmed to concurrently transmit data at different rates.

Transmit (“XMT”) DMA Module 135:

FIG. 1D shows a block diagram of the transmit side (“XMT”) DMA module 135 having plural DMA channels 147, 148 and 149.It is noteworthy that the adaptive aspects of the present invention are not limited to any particular number of DMA channels.

Module 135 is coupled to state machine 146 in PCI core 137. Transmit Scheduler 134 (shown in FIG. 1B) configures the DMA channels (147, 148 and 149) to make a request to arbiter 107 at a rate similar to the receiving rate of the destination device. This interleaves frames from plural contexts to plural devices, and hence efficiently uses a high-speed link bandwidth.

Data moves from frame buffer 111B to SERDES 136, which converts serial data into parallel data. Data from SERDES 136 moves to the appropriate device at the rate at which the device can accept the data.

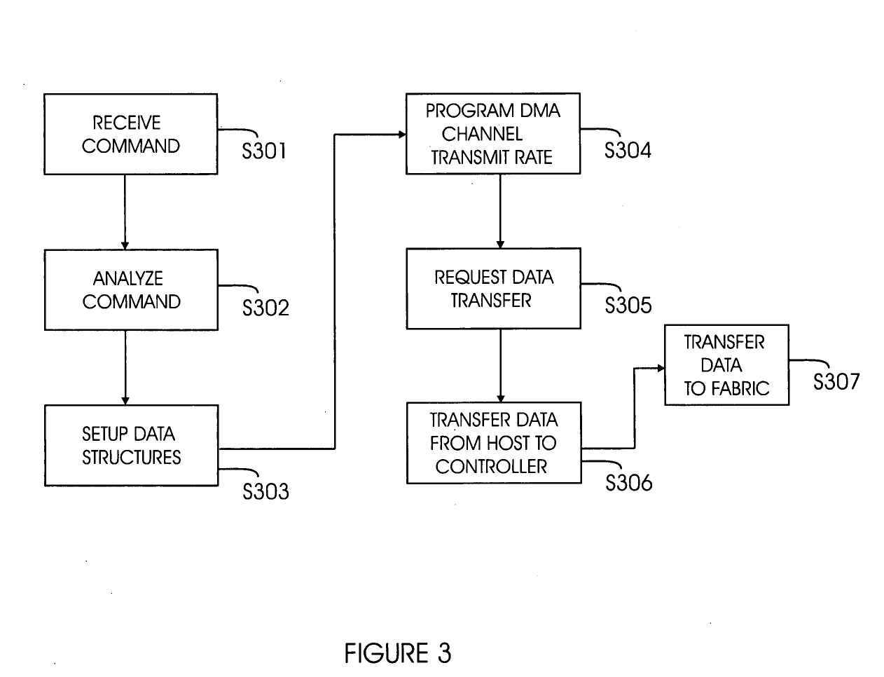

FIG. 3 shows a process flow diagram of executable process steps used for transferring data by programming plural DMA channels to transmit data at different rates for different I/Os', according to one aspect of the present invention.

Turning in detail to FIG. 3, in step S301, host processor 202 receives a command to transfer data. The command complies with the fiber channel protocols defined above. Host driver 102 writes preliminary information regarding the command (IOCB) in system memory 101 and updates request queue pointers in mailboxes (not shown).

In step S302, processor 106A reads the IOCB, determines what operation is to be performed (i.e. read or write), how much data is to be transferred, where in the system memory 101 data is located, and the rate at which the receiving device can receive the data (for a write command).

In step S303, processor 106A sets up the data structures in local memory (i.e. 108 or 110).

In step S304, the DMA channel (147,148 or 149) is programmed to transmit data at a rate similar to the receiving device's link transfer rate. As discussed above, this information is available during login and when the communication between host system 200 and the device is initialized. Plural DMA channels may be programmed to transmit data concurrently at different rates for different I/O operations.

In step S305, DMA module 135 sends a request to arbiter 107 to gain access to the PCI bus.

In step S306, access to the particular DMA channel is provided and data is transferred from buffer memory 108 (and/or 110) to frame buffer 11B.

In step S307, data is moved to SERDES module 136 for transmission to the appropriate device via fabric 140. Data transfer complies with the various fiber channel protocols, defined above.

In one aspect of the present invention, the foregoing process is useful in a RAID environment. In a RAID topology, data is stored across plural disks and a storage system can include a number of disk storage devices that can be arranged with one or more RAID levels.

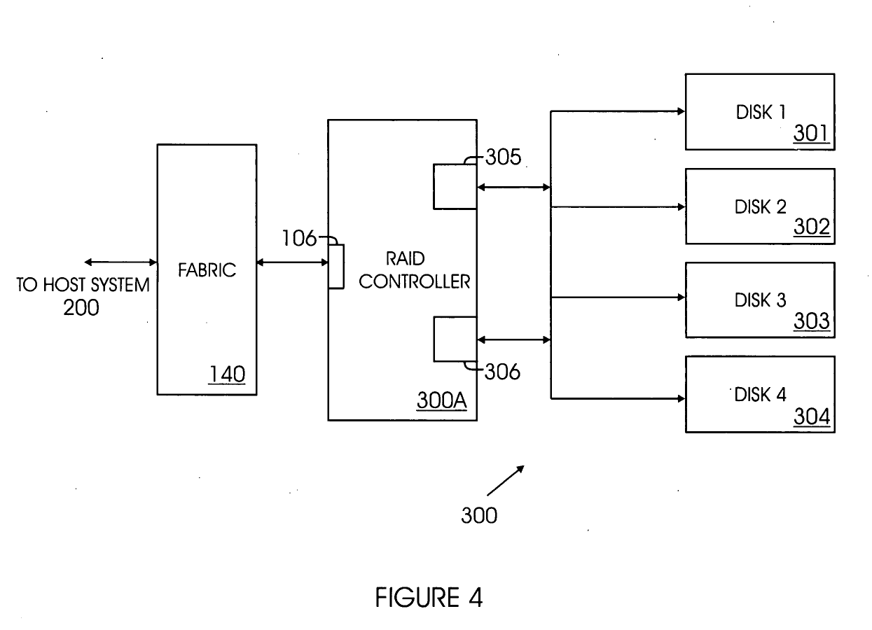

FIG. 4 shows a simple example of a RAID topology that can use one aspect of the present invention. FIG. 4 shows a RAID controller 300A coupled to plural disks 301, 302, 303 and 304 using ports 305 and 306. Fiber channel fabric 140 is coupled to RAID controller 300A through HBA 106.

Plural DMA channels can be programmed as described above to transmit data concurrently at different rates when the transfer rate(s) of the receiving links is lower than the transmit rate.

The term storage device, system, disk, disk drive and drive are used interchangeably in this description. The terms specifically include magnetic storage devices having rotatable platter(s) or disk(s), digital video disks (DVD), CD-ROM or CD Read/Write devices, removable cartridge media whether magnetic, optical, magneto-optical and the like. Those workers having ordinary skill in the art will appreciate the subtle differences in the context of the description provided herein.

Although the present invention has been described with reference to specific embodiments, these embodiments are illustrative only and not limiting. Many other applications and embodiments of the present invention will be apparent in light of this disclosure and the following claims. The foregoing adaptive aspects are useful for any networking environment where there is disparity between link transfer rates.

What is claimed is:

1. A system for transferring data from a host system to plural devices wherein the plural devices are coupled to links that may have a different serial rate for accepting data from the host system, comprising:
a plurality of programmable DMA channels operating concurrently to transmit data at a rate similar to a rate at which the plural devices will accept data.

2. The system of claim 1, further comprising: arbitration logic that receives requests from a specific DMA channel to transfer data to a device.

3. The system of claim 1, wherein the host system is a part of a storage area network.

4. The system of claim 1, wherein the plural devices are fibre channel devices.

5. The system of claim 1, wherein the plural devices are non-fibre channel devices.

6. The system of claim 1, wherein a fabric is used to couple the host system to the plural devices.

7. A circuit for transferring data from a host system to plural devices wherein the plural devices are coupled to links that may have a different serial rate for accepting data from the host system, comprising:
a plurality of programmable DMA channels operating concurrently to transmit data at a rate similar to a rate at which the plural devices will accept data.

8. The circuit of claim 7, further comprising: arbitration logic that receives requests from a specific DMA channel to transfer data to a device.

9. The circuit of claim 7, wherein the host system is a part of a storage area network.

10. The circuit of claim 7, wherein the plural devices are fibre channel devices.

11. The circuit of claim 7, wherein the plural devices are non-fibre channel devices.

12. A method for transferring data from a host system to plural devices wherein the plural devices are coupled to links that may have different serial rates for accepting data from the host system, comprising:
programming plural DMA channels to concurrently transmit data at a rate similar to a rate at which a receiving device will accept data; and
transferring data from a memory buffer at a data rate similar to a rate at which the receiving device will accept the data.

13. The method of claim 12, wherein the host system is a part of a storage area network.

14. The method of claim 12, wherein the plural devices are fibre channel devices.

15. The method of claim 12, wherein the plural devices are non-fibre channel devices.
